(19) United States
(12) Patent Application Publication
(10) Pub. No.: US 2026/0259395 A1
(43) Pub. Date: Sep. 3, 2026

(54) ZOOM LENS AND IMAGE PICKUP APPARATUS HAVING THE SAME

(71) Applicant: CANON KABUSHIKI KAISHA, Tokyo (JP)

(72) Inventor: Shunji IWAMOTO, Tochigi (JP)

(21) Appl. No.: 19/546,497

(22) Filed: Feb. 23, 2026

(30) Foreign Application Priority Data
Feb. 28, 2025 (JP) 2025-031312

(51) Int. Cl. G02B 13/00; G02B 15/14; H04N 23/55

(52) U.S. Cl. CPC G02B 13/009; G02B 13/006; G02B 15/1461; H04N 23/55

(57) ABSTRACT

A zoom lens may include, in order from an object side to an image side, a front group, an intermediate group, and a rear group, each of which includes one or more lens units. Each distance between adjacent lens units may change during zooming. The front group may consist of a first front lens unit with positive refractive power. The first front lens unit may be fixed relative to an image plane during zooming. The intermediate group may consist of, in order from the object side to the image side, a first intermediate lens unit with negative refractive power, a second intermediate lens unit with negative refractive power, and a third intermediate lens unit. The third intermediate lens unit moves from the object side to the image side during zooming from a wide-angle end to a telephoto end. Predetermined inequalities are satisfied.

### BACKGROUND

### Field of the Technology

The present disclosure relates to a zoom lens and an image pickup apparatus having the same.

### Description of the Related Art

Recent zoom lenses are demanded to have a reduced size, a high zoom ratio (magnification (variation) ratio), and the ability to satisfactorily correct various aberrations and perform high-speed zoom operation.

### SUMMARY

A zoom lens according to one aspect of the present disclosure may include, in order from an object side to an image side, a front group, an intermediate group, and a rear group, each of which includes one or more lens units. Each distance between adjacent lens units may change during zooming. The front group may consist of a first front lens unit with positive refractive power. The first front lens unit may be fixed relative to an image plane during zooming. The intermediate group may consist of, in order from the object side to the image side, a first intermediate lens unit with negative refractive power, a second intermediate lens unit with negative refractive power, and a third intermediate lens unit. The third intermediate lens unit may move from the object side to the image side during zooming from a wide-angle end to a telephoto end. The following inequalities may be satisfied:

$$0.001 < TLM 1 / fLF 1 < 0 \text{.025}$$

$$0.001 < TLM 2 / fLF 1 < 0.0 \; 22$$

$$0.1 < MLM 1 / fLF 1 < 0.39$$

where fLF1 is a focal length of the first front lens unit, TLM1 is a distance on an optical axis from a lens surface closest to an object in the first intermediate lens unit to a lens surface closest to the image plane in the first intermediate lens unit, TLM2 is a distance on the optical axis from a lens surface closest to the object in the second intermediate lens unit to a lens surface closest to the image plane in the second intermediate lens unit, and MLM1 is a moving amount, where the moving amount toward the object side is positive, of the first intermediate lens unit during zooming from the wide-angle end to the telephoto end. An image pickup apparatus having the above zoom lens also constitutes another aspect of the present disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a sectional view of a zoom lens according to Example 1 in an in-focus state on an object at infinity at a wide-angle end.

FIG. 2A is an aberration diagram of the zoom lens according to Example 1 in the in-focus state on the object at infinity at the wide-angle end, and FIG. 2B is an aberration diagram of the zoom lens according to Example 1 in an in-focus state on an object at infinity at a telephoto end.

FIG. 3 is a sectional view of a zoom lens according to Example 2 in an in-focus state on an object at infinity at a wide-angle end.

FIG. 4A is an aberration diagram of the zoom lens according to Example 2 in the in-focus state on the object at infinity at the wide-angle end, and FIG. 4B is an aberration diagram of the zoom lens according to Example 2 in an in-focus state on an object at infinity at a telephoto end.

FIG. 5 is a sectional view of a zoom lens according to Example 3 in an in-focus state on an object at infinity at a wide-angle end.

FIG. 6A is an aberration diagram of the zoom lens according to Example 3 in the in-focus state on the object at infinity at the wide-angle end, and FIG. 6B is an aberration diagram of the zoom lens according to Example 3 in an in-focus state on an object at infinity at a telephoto end.

FIG. 7 is a sectional view of a zoom lens according to Example 4 in an in-focus state on an object at infinity at a wide-angle end.

FIG. 8A is an aberration diagram of the zoom lens according to Example 4 in the in-focus state on the object at infinity at the wide-angle end, and FIG. 8B is an aberration diagram of the zoom lens according to Example 4 in an in-focus state on an object at infinity at a telephoto end.

FIG. 9 is a sectional view of a zoom lens according to Example 5 in an in-focus state on an object at infinity at a wide-angle end.

FIG. 10A is an aberration diagram of the zoom lens according to Example 5 in the in-focus state on the object at infinity at the wide-angle end, and FIG. 10B is an aberration diagram of the zoom lens according to Example 5 in an in-focus state on an object at infinity at a telephoto end.

FIG. 11 is a sectional view of a zoom lens according to Example 6 in an in-focus state on an object at infinity at a wide-angle end.

FIG. 12A is an aberration diagram of the zoom lens according to Example 6 in the in-focus state on the object at infinity at the wide-angle end, and FIG. 12B is an aberration diagram of the zoom lens according to Example 6 in an in-focus state on an object at infinity at a telephoto end.

FIG. 13 is a schematic diagram of an image pickup apparatus.

### DESCRIPTION OF THE EMBODIMENTS

Referring now to the accompanying drawings, a detailed description will be given of embodiments according to the present disclosure. Corresponding elements in respective figures will be designated by the same reference numerals, and a duplicate description thereof will be omitted.

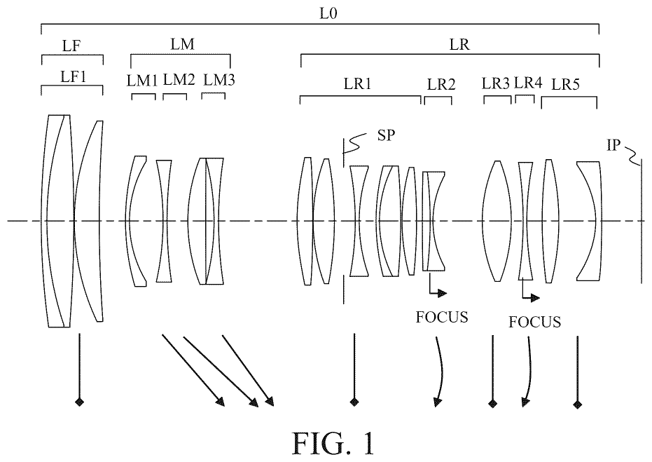

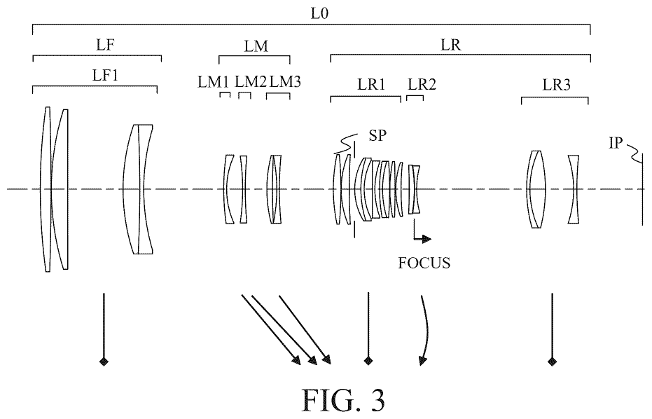

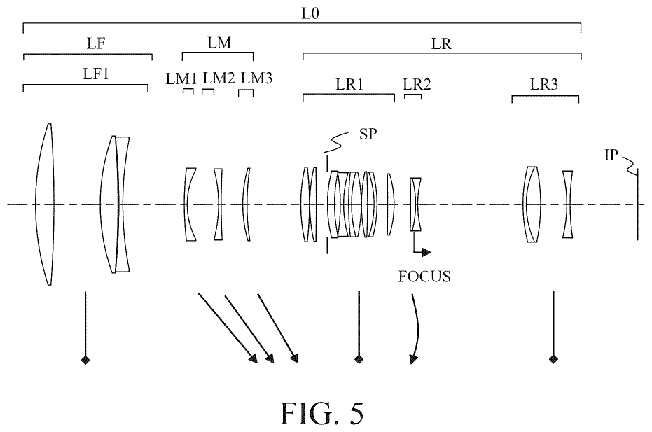

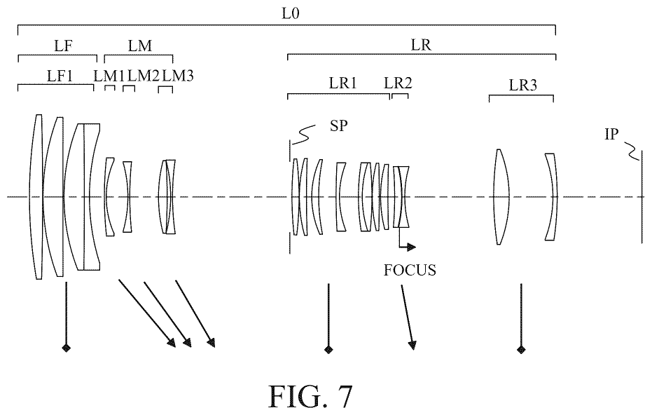

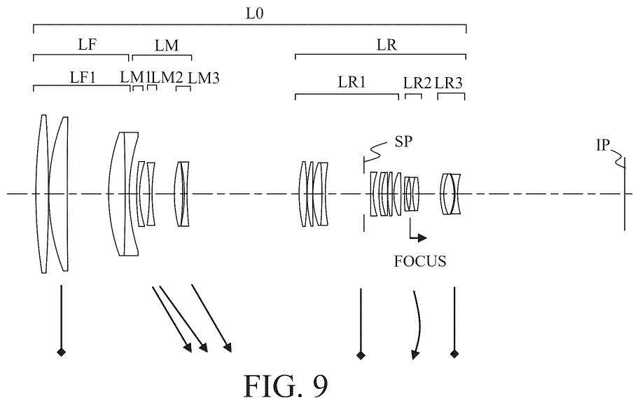

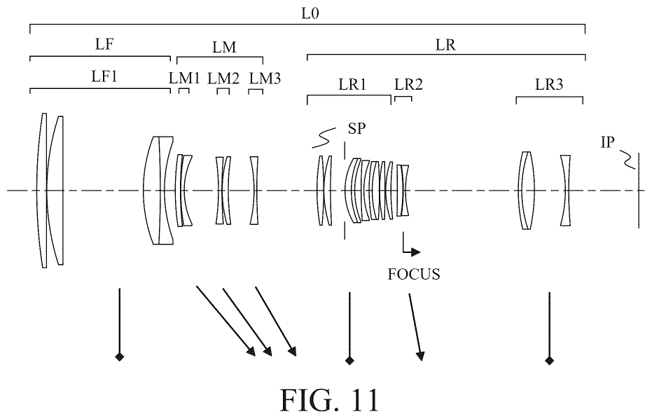

FIGS. 1, 3, 5, 7, 9, and 11 are sectional views of zoom lenses according to Examples 1 to 6 in an in-focus state on an object at infinity (referred to as an “in-focus state at infinity” hereinafter) at a wide-angle end. The zoom lens L0 according to each example is used for an image pickup apparatus such as a digital video camera, a digital still camera, a broadcasting camera, a film-based camera, a surveillance camera, and an on-board (in-vehicle) camera.

In each sectional view, the left side is the object side and the right side is the image side. The zoom lens L0 according to each example may also be used as a projection lens for a projector or the like. In this case, the left side is the screen side and the right side is the projected image side.

The zoom lens L0 according to each example includes a plurality of lens units. In this specification, a lens unit refers to a group of lenses that move or remain stationary as a unit during zooming (magnification variation). That is, in the zoom lens L0 according to each example, each distance between adjacent lens units changes during zooming. A lens unit may consist of one or more lenses. The lens units may also include an aperture stop.

The zoom lens L0 according to each example consists of, in order from the object side to the image side, a front group LF, an intermediate group LM, and a rear group LR, each of which includes at least one lens unit.

In each sectional view, LFi represents an i-th (where i is a natural number) lens unit included in the front group LF, counted from the object side. LMi represents an i-th (where i is a natural number) lens unit included in the intermediate group LM, counted from the object side. LRi represents an i-th (where i is a natural number) lens unit included in the rear group LR, counted from the object side.

SP represents an aperture stop, which determines (limits) a light beam at the maximum F-number (Fno). I represents an image plane, on which an imaging surface of an image sensor (photoelectric conversion element) such as a CCD sensor or CMOS sensor is disposed when the zoom lens L0 according to each example is used as the imaging optical system for a digital still camera or digital video camera. When the zoom lens according to each example is used as an imaging optical system of a film-based camera, a photosensitive surface equivalent to a film surface is disposed on the image plane I.

A solid arrow indicates a moving locus of each lens unit during zooming from the wide-angle end to the telephoto end. During focusing from an object at infinity to the closest object, a lens unit (focus unit) moves as illustrated by the arrow labeled FOCUS.

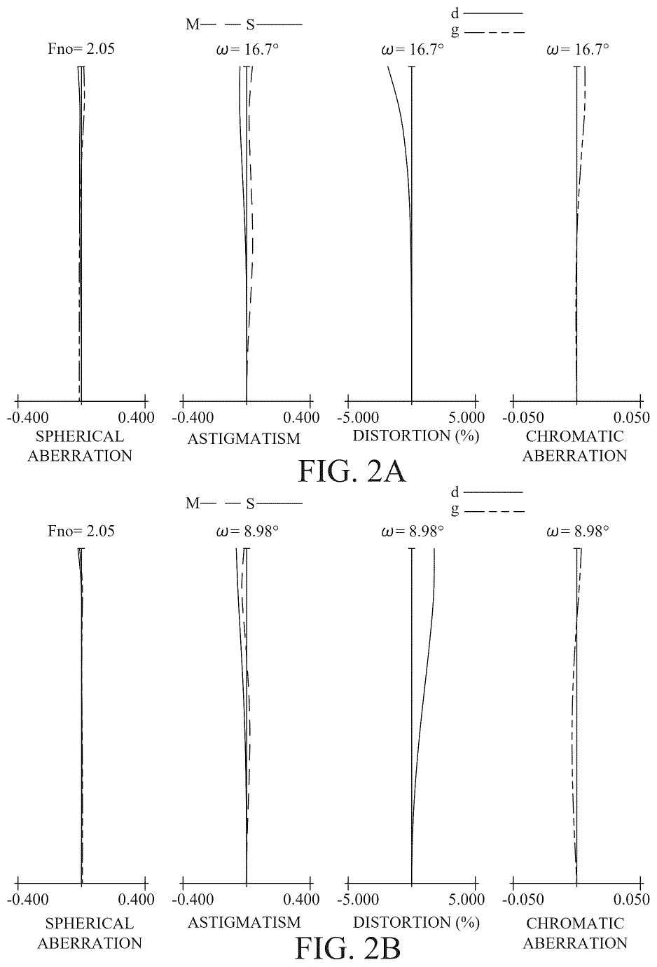

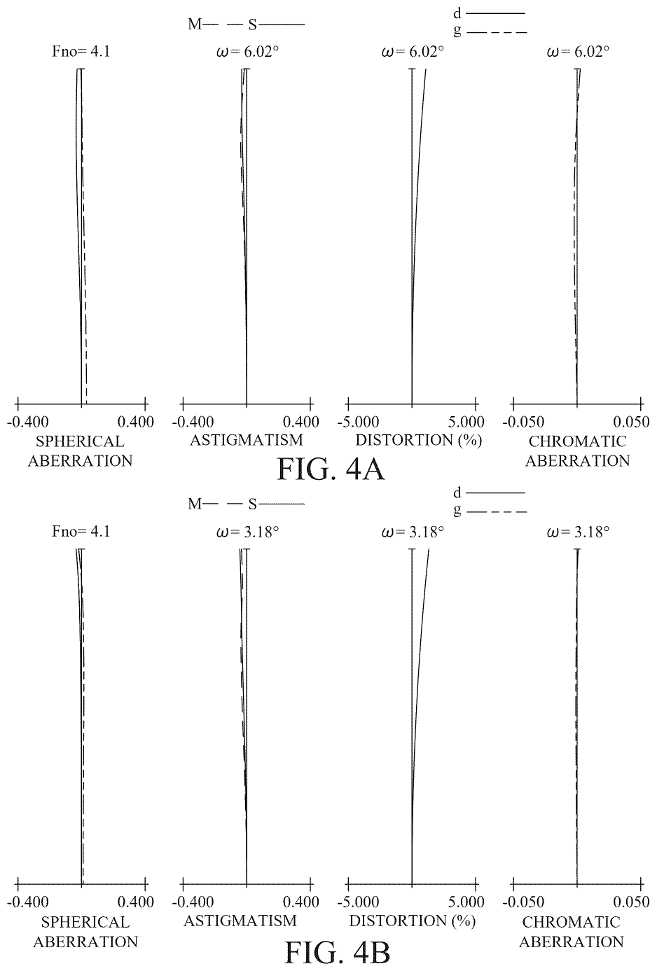

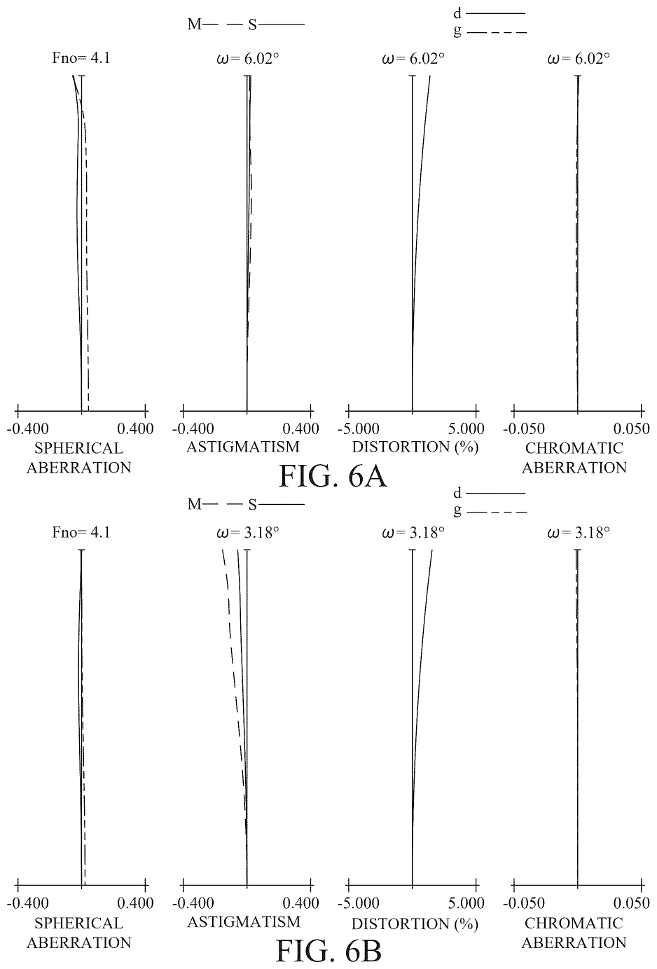

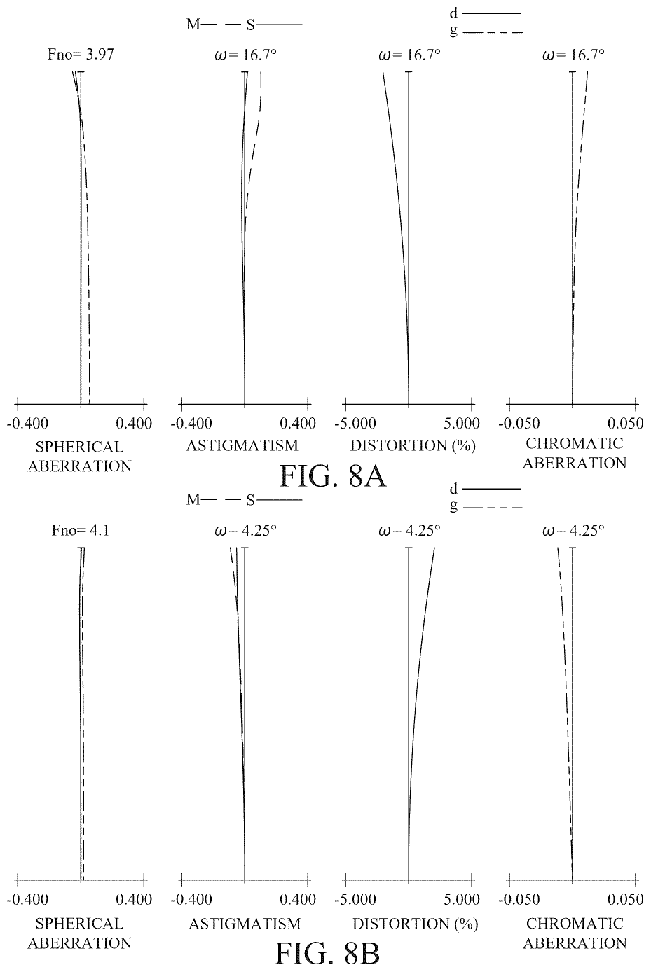

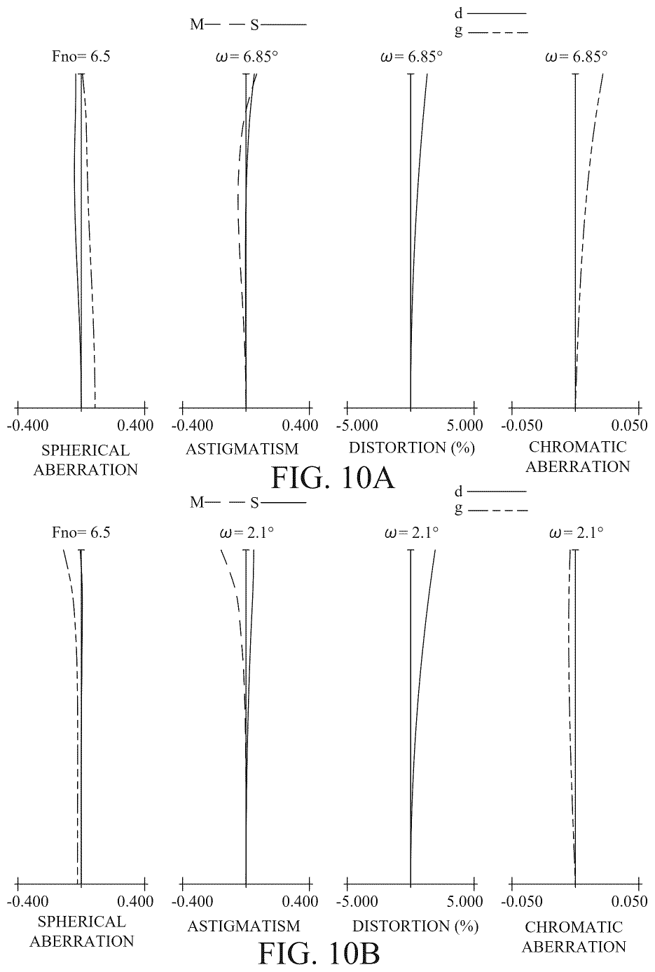

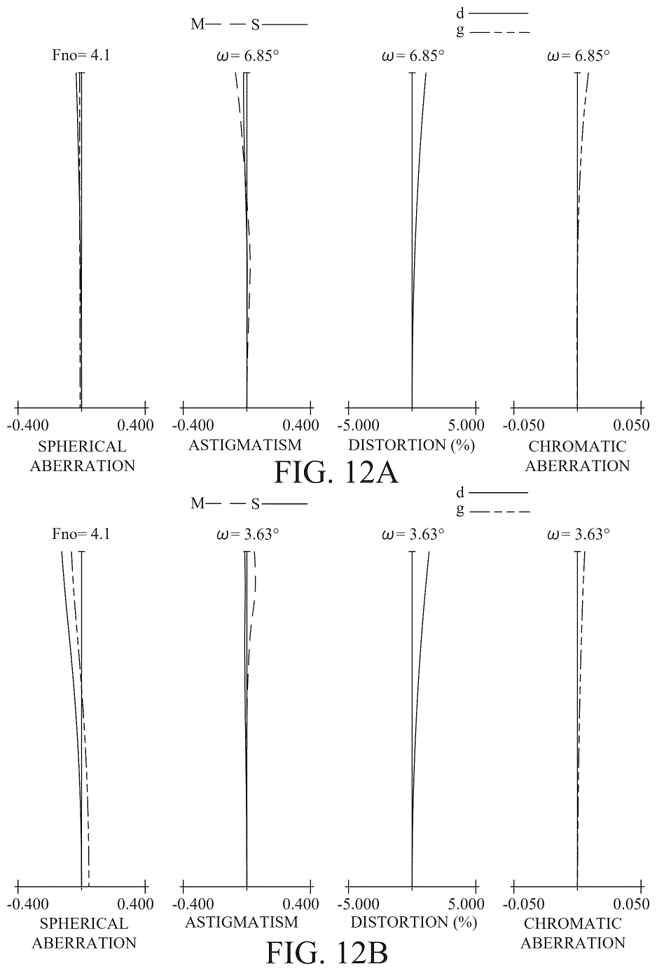

FIGS. 2A, 2B, 4A, 4B, 6A, 6B, 8A, 8B, 10A, 10B, 12A, and 12B are aberration diagrams of the zoom lenses L0 according to Examples 1 to 6, respectively, in an in-focus state at infinity. In each aberration diagram, FIGS. 2A, 4A, 6A, 8A, 10A, and 12A are the aberration diagrams at the wide-angle end, and FIGS. 2B, 4B, 6B, 8B, 10B, and 12B are the aberration diagrams at the telephoto end.

In the spherical aberration diagram, Fno represents an F-number. The spherical aberration diagram indicates spherical aberration amounts for the d-line (wavelength 587.56 nm) and the g-line (wavelength 435.8 nm). In the astigmatism diagram, S indicates an astigmatism amount on a sagittal image plane for the d-line, and M indicates an astigmatism amount on a meridional image plane for the d-line. The distortion diagram indicates a distortion amount for the d-line. The chromatic aberration diagram indicates a chromatic aberration amount for the g-line. ω is half an angle of view [° ] calculated by paraxial calculation.

The characteristic configuration of the zoom lens L0 according to each example will be described below.

The front group LF consists of a first front lens unit LF1 with positive refractive power. The first front lens unit LF1 is fixed relative to the image plane during zooming. Maintaining fixed during zooming the first front lens unit LF1 that tends to have a relatively large lens diameter and mass can facilitate a high-speed zoom operation.

The intermediate group LM consists of, in order from the object side to the image side, a first intermediate lens unit LM1, a second intermediate lens unit LM2, and a third intermediate lens unit LM3.

A description will be given of configurations that may be satisfied by the zoom lens L0 according to each example.

The third intermediate lens unit LM3 may move from the object side to the image side during zooming from the wide-angle end to the telephoto end. Thereby, it becomes easier to reduce the diameter and weight of the third intermediate lens unit LM3 and achieve a high-speed zoom operation.

The first rear lens unit LR1, which is disposed closest to the object among the lens units included in the rear group LR, may have positive refractive power. Thereby, it becomes easier to reduce the overall length and the size.

The first rear lens unit LR1 may be fixed relative to the image plane during zooming. Thereby, the mechanism can be simple and the size can be reduced.

The first rear lens unit LR1 may include the aperture stop SP. Thereby, optimal aberration correction before and after the aperture stop SP can be proper, and high image quality can be achieved.

Of the lens units included in the rear group LR, the second rear lens unit LR2, which is adjacent to and disposed on the image side of the first rear lens unit LR1, may move during zooming. Thereby, aberrations in the rear group LR can be properly corrected, and it becomes easier to achieve high image quality.

The second rear lens unit LR2 may move during focusing. Placing a lens unit that moves during focusing on the image side, where the lens diameter is relatively small, can provide a simple mechanism and reduce the size.

The second rear lens unit LR2 may have negative refractive power. The rear group LR having a telephoto configuration can easily reduce the overall length.

The lens unit disposed closest to the image plane may be fixed relative to the image plane during zooming. Fixing lenses near the image plane with relatively large lens diameters relative to the image plane during zooming can provide a simple mechanism and reduce the size.

The front group LF and the intermediate group LM may be fixed relative to the image plane during focusing. Fixing the object-side lens, which has a relatively large lens diameter, relative to the image plane during focusing can provide a simple mechanism and reduce the size.

The first rear lens unit LR1 may have a positive lens disposed closest to the object. Thereby, a telephoto configuration can be achieved, and it becomes easier to reduce the overall length.

A description will be given of conditions that may be satisfied by the zoom lens L0 according to each example. The zoom lens according to each example may satisfy one or more of the following inequalities (1) to (15):

$$0.001 < TLM 1 / fLF 1 < 0 \text{.025} \qquad ( 1 )$$

$$0.001 < TLM 2 / fLF 1 < 0.0 \; 22 \qquad ( 2 )$$

$$0.2 < fLF 1 / ft < 2.1 \qquad ( 3 )$$

$$- 3.4 < fw / fLM 1 < - 0.3 \qquad ( 4 )$$

$$- 4.5 < fw / fLM 2 < - 0.2 \qquad ( 5 )$$

$$- 2.8 < fw / fLM 3 < 2.3 \qquad ( 6 )$$

$$0.7 < fw / fLR 1 < 7.6 \qquad ( 7 )$$

$$0.1 < MLM 1 / fLF 1 < 0.8 \qquad ( 8 )$$

$$0.1 < MLM 2 / fLF 1 < 0.8 \qquad ( 9 )$$

$$0.1 < MLM 3 / fLF 1 < 0.6 \qquad ( 10 )$$

$$- 2.5 < β LRw < - 0.2 \qquad ( 11 )$$

$$0.3 < β LRt / β LRw < 2.7 \qquad ( 12 )$$

$$- 8.8 < β LMt < - 0.5 \qquad ( 13 )$$

$$0.1 < BFw / fw < 1.1 \qquad ( 14 )$$

$$0.3 < Lt / ft < 3. 1 \qquad ( 15 )$$

Here, fLF1 is a focal length of the first front lens unit LF1. TLM1 is a thickness of the first intermediate lens unit LM1, i.e., a distance on the optical axis from a lens surface (surface vertex) closest to the object in the first intermediate lens unit LM1 to a lens surface (surface vertex) closest to the image plane in the first intermediate lens unit LM1. TLM2 is a thickness of the second intermediate lens unit LM2, i.e., a distance on the optical axis from a lens surface (surface vertex) closest to the object in the second intermediate lens unit LM2 to a lens surface (surface vertex) closest to the image plane in the second intermediate lens unit LM2. ft is a focal length of the zoom lens L0 in the in-focus state at infinity at the telephoto end. fw is a focal length of the zoom lens L0 in the in-focus state at infinity at the wide-angle end. fLM1 is a focal length of the first intermediate lens unit LM1. fLM2 is a focal length of the second intermediate lens unit LM2. fLM3 is a focal length of the third intermediate lens unit LM3. fLR1 is a focal length of the first rear lens unit LR1. MLM1 is a moving amount (where the moving amount toward the object side is positive) of the first intermediate lens unit LM1 during zooming from the wide-angle end to the telephoto end. MLM2 is a moving amount (where the moving amount toward the object side is positive) of the second intermediate lens unit LM2 during zooming from the wide-angle end to the telephoto end. MLM3 is a moving amount (where the moving amount toward the object side is positive) of the third intermediate lens unit LM3 during zooming from the wide-angle end to the telephoto end. βLRw is a combined lateral magnification of the rear group LR at the wide-angle end. βLRt is a combined lateral magnification of the rear group LR at the telephoto end. βLMt is a combined lateral magnification of the intermediate group LM at the telephoto end. BFw is a back focus in the in-focus state at infinity at the wide-angle end. The back focus is a distance on the optical axis from an image-side lens surface (surface vertex) of the lens disposed closest to the image plane among the lenses with power to the image plane. In a case where a flat plate or the like is included between the lens closest to the image plane and the image plane, a distance is calculated in air-equivalent conversion. Lt is a distance on the optical axis from the object-side lens surface (surface vertex) to the image plane in the in-focus state at infinity at the telephoto end.

Inequality (1) defines a proper thickness of the first intermediate lens unit LM1. In a case where the thickness of the first intermediate lens unit LM1 increases and TLM1/fLF1 becomes higher than the upper limit of inequality (1), the mass of the first intermediate lens unit LM1 increases, and it becomes difficult to achieve a high-speed zoom operation. In a case where the thickness of the first intermediate lens unit LM1 reduces, and TLM1/fLF1 becomes lower than the lower limit of inequality (1), it becomes difficult to correct various aberrations, particularly astigmatism at the telephoto end.

Inequality (2) defines a proper thickness of the second intermediate lens unit LM2. In a case where the thickness of the second intermediate lens unit LM2 increases and TLM2/fLF1 becomes higher than the upper limit of inequality (2), it becomes difficult to achieve a high-speed zoom operation. In a case where the thickness of the second intermediate lens unit LM2 reduces and TLM2/fLF1 becomes lower than the lower limit of inequality (2), it becomes difficult to correct various aberrations, particularly astigmatism at the telephoto end.

Inequality (3) defines a proper relationship between the focal length of the first front lens unit LF1 and the focal length of the zoom lens L0 in the in-focus state at infinity at the telephoto end. In a case where fLF1/ft becomes higher than the upper limit of inequality (3), it becomes difficult to reduce the overall length, and the size of the zoom lens L0 increases. In a case where fLF1/ft becomes lower than the lower limit of inequality (3), it becomes difficult to correct various aberrations, particularly chromatic aberration at the telephoto end.

Inequality (4) defines a proper relationship between the focal length of the first intermediate lens unit LM1 and the focal length of the zoom lens L0 in the in-focus state at infinity at the wide-angle end. In a case where fw/fLM1 becomes higher than the upper limit of inequality (4), it becomes difficult to achieve a high magnification variation ratio. In a case where fw/fLM1 becomes lower than the lower limit of inequality (4), it becomes difficult to correct various aberrations, particularly spherical aberration at the telephoto end.

Inequality (5) defines a proper relationship between the focal length of the second intermediate lens unit LM2 and the focal length of the zoom lens L0 in the in-focus state at infinity at the wide-angle end. In a case where fw/fLM2 becomes higher than the upper limit of inequality (5), it becomes difficult to achieve a high magnification variation ratio. In a case where fw/fLM2 becomes lower than the lower limit of inequality (5), it becomes difficult to correct various aberrations, particularly spherical aberration at the telephoto end.

Inequality (6) defines a proper relationship between the focal length of the third intermediate lens unit LM3 and the focal length of the zoom lens L0 in an in-focus state on an object at infinity at the wide-angle end. In a case where fw/fLM3 becomes higher than the upper limit of inequality (6), it becomes difficult to correct various aberrations, particularly spherical aberration at the telephoto end. In a case where fw/fLM3 becomes lower than the lower limit of inequality (6), the size of the zoom lens L0 increases.

Inequality (7) defines a proper relationship between the focal length of the first rear lens unit LR1 and the focal length of the zoom lens L0 in the in-focus state at infinity at the wide-angle end. In a case where fw/fLR1 becomes higher than the upper limit of inequality (7), it becomes difficult to correct various aberrations, particularly spherical aberration at the telephoto end. In a case where fw/fLR1 becomes lower than the lower limit of inequality (7), the size of the zoom lens L0 increases.

Inequality (8) defines a proper relationship between the moving amount of the first intermediate lens unit LM1 during zooming from the wide-angle end to the telephoto end and the focal length of the first front lens unit LF1. In a case where MLM1/fLF1 becomes higher than the upper limit of inequality (8), the size of the zoom lens L0 increases. In a case where MLM1/fLF1 becomes lower than the lower limit of inequality (8), it becomes difficult to achieve high magnification variation.

Inequality (9) defines a proper relationship between the moving amount of the second intermediate lens unit LM2 during zooming from the wide-angle end to the telephoto end and the focal length of the first front lens unit LF1. In a case where MLM2/fLF1 becomes higher than the upper limit of inequality (9), the size of the zoom lens L0 increases. In a case where MLM2/fLF1 becomes lower than the lower limit of inequality (9), it becomes difficult to achieve high magnification variation.

Inequality (10) defines a proper relationship between the moving amount of the third intermediate lens unit LM3 during zooming from the wide-angle end to the telephoto end and the focal length of the first front lens unit LF1. In a case where MLM3/fLF1 becomes higher than the upper limit of inequality (10), the size of the zoom lens L0 increases. In a case where MLM3/fLF1 becomes lower than the lower limit of inequality (10), it becomes difficult to achieve high magnification variation.

Inequality (11) defines a proper combined lateral magnification of the rear group LR at the wide-angle end. In a case where βLRw becomes higher than the upper limit of inequality (11), it becomes difficult to correct various aberrations, particularly curvature of field at the optical end. In a case where βLRw becomes lower than the lower limit of inequality (11), it becomes difficult to correct various aberrations, particularly curvature of field at the optical end.

Inequality (12) defines a proper relationship between the combined lateral magnification of the rear group LR at the wide-angle end and the combined lateral magnification of the rear group LR at the telephoto end. In a case where βLRt/βLRw becomes higher than the upper limit of inequality (12), it becomes difficult to correct various aberrations, particularly curvature of field at the telephoto end. In a case where βLRt/βLRw becomes lower than the lower limit of inequality (12), it becomes difficult to achieve high magnification variation.

Inequality (13) defines a proper combined lateral magnification of the intermediate group LM at the telephoto end. In a case where βLMt becomes higher than the upper limit of inequality (13), the focal length at the telephoto end becomes too short. In a case where βLMt becomes lower than the lower limit of inequality (13), it becomes difficult to correct various aberrations, particularly astigmatism at the telephoto end.

Inequality (14) defines a proper relationship between the back focus in the in-focus state at infinity at the wide-angle end and the focal length of zoom lens L0 in the in-focus state at infinity at the wide-angle end. In a case where the back focus increases and BFw/fw becomes higher than the upper limit of inequality (14), the size of the zoom lens L0 increases. In a case where the back focus reduces and BFw/fw becomes lower than the lower limit of inequality (14), the diameter of the rear lens increases.

Inequality (15) defines a proper relationship between the distance on the optical axis from the lens surface closest to the object to the image plane in the in-focus state at infinity at the telephoto end and the focal length of zoom lens L0 in the in-focus state at infinity at the telephoto end. In a case where Lt/ft becomes higher than the upper limit of inequality (15), the size of the zoom lens L0 increases. In a case where Lt/ft becomes lower than the lower limit of inequality (15), it becomes difficult to correct various aberrations, particularly curvature of field at the telephoto end.

The lower limit of inequality (1) may be set to 0.0015, 0.0020, 0.0025, 0.0030, 0.0035, 0.0040, 0.0042, 0.0044, 0.0046, or 0.0048. The upper limit of inequality (1) may be set to 0.0240, 0.0230, 0.0225, 0.0220, 0.0215, 0.0210, 0.0205, 0.0200, 0.0195, or 0.0190.

The lower limit value of inequality (2) may be set to 0.0015, 0.0020, 0.0025, 0.0030, 0.0035, 0.0040, 0.0042, 0.0044, 0.0046, or 0.0048. The upper limit value of inequality (2) may be set to 0.0218, 0.0216, 0.0214, 0.0212, 0.0210, 0.0209, 0.0208, 0.0207, 0.0206, or 0.0205.

The lower limit value of inequality (3) may be set to 0.22, 0.25, 0.28, 0.31, 0.34, 0.37, 0.39, 0.40, 0.41, or 0.42. The upper limit of inequality (3) may be set to 2.00, 1.80, 1.60, 1.40, 1.30, 1.20, 1.16, 1.13, 1.10, or 1.08.

The lower limit of inequality (4) may be set to −3.2, −3.0, −2.8, −2.6, −2.4, −2.2, −2.1, −2.0, −1.9, or −1.8. The upper limit of inequality (4) may be set to −0.35, −0.40, −0.45, −0.50, −0.55, −0.57, −0.59, −0.61, −0.63, or −0.65.

The lower limit of inequality (5) may be set to −4.1, −3.9, −3.7, −3.5, −3.3, −3.1, −2.9, −2.7, −2.5, or −2.3. The upper limit of inequality (5) may be set to −0.22, −0.24, −0.25, −0.26, −0.27, −0.28, −0.29, −0.30, −0.31, or −0.32.

The lower limit of inequality (6) may be set to −2.6, −2.4, −2.2, −2.0, −1.9, −1.8, −1.7, −1.6, −1.5, or −1.4. The upper limit of inequality (6) may be set to 2.2, 2.0, 1.9, 1.8, 1.7, 1.6, 1.5, 1.4, 1.3, or 1.2.

The lower limit of inequality (7) may be set to 0.80, 1.00, 1.05, 1.10, 1.15, 1.20, 1.25, 1.30, 1.35, or 1.40. The upper limit of inequality (7) may be set to 7.4, 7.0, 6.6, 6.2, 5.8, 5.4, 5.0, 4.6, 4.2, or 3.8.

The lower limit of inequality (8) may be set to 0.110, 0.120, 0.125, 0.130, 0.135, 0.140, 0.145, 0.150, 0.155, or 0.158. The upper limit of inequality (8) may be set to 0.75, 0.70, 0.65, 0.60, 0.55, 0.50, 0.45, 0.40, 0.39, or 0.38.

The lower limit value of inequality (9) may be set to 0.110, 0.116, 0.118, 0.120, 0.122, 0.124, 0.126, 0.128, 0.130, or 0.132. The upper limit value of inequality (9) may be set to 0.75, 0.70, 0.65, 0.60, 0.55, 0.50, 0.45, 0.40, 0.39, or 0.38.

The lower limit value of inequality (10) may be set to 0.101, 0.103, 0.104, 0.105, 0.106, 0.107, 0.108, 0.109, 0.110, or 0.111. The upper limit of inequality (10) may be set to 0.55, 0.50, 0.45, 0.40, 0.36, 0.35, 0.34, 0.33, 0.32, or 0.31.

The lower limit of inequality (11) may be set to −2.4, −2.2, −2.0, −1.9, −1.8, −1.7, −1.6, −1.5, −1.4, or −1.3. The upper limit of inequality (11) may be set to −0.21, −0.24, −0.27, −0.30, −0.33, −0.36, −0.39, −0.42, −0.45, or −0.48.

The lower limit of inequality (12) may be set to 0.35, 0.40, 0.45, 0.50, 0.55, 0.56, 0.57, 0.58, 0.59, or 0.60. The upper limit of inequality (12) may be set to 2.5, 2.3, 2.1, 2.0, 1.9, 1.8, 1.7, 1.6, 1.5, or 1.4.

The lower limit of inequality (13) may be set to −8.5, −8.0, −7.5, −7.0, −6.5, −6.0, −5.5, −5.0, −4.7, or −4.5. The upper limit of inequality (13) may be set to −0.55, −0.60, −0.65, −0.70, −0.75, −0.80, −0.85, −0.90, −0.95, or −1.00.

The lower limit of inequality (14) may be set to 0.110, 0.120, 0.130, 0.140, 0.150, 0.160, 0.170, 0.180, 0.185, or 0.190. The upper limit of inequality (14) may be set to 1.00, 0.90, 0.80, 0.70, 0.66, 0.64, 0.62, 0.60, 0.58, or 0.56.

The lower limit of inequality (15) may be set to 0.35, 0.40, 0.44, 0.48, 0.50, 0.52, 0.54, 0.56, 0.57, or 0.58. The upper limit of inequality (15) may be set to 3.0, 2.8, 2.6, 2.4, 2.2, 2.0, 1.9, 1.8, 1.7, or 1.6.

Next, the zoom lens L0 according to each example will be described in detail.

The zoom lens L0 according to Example 1 consists of, in order from the object side to the image side, a front group LF, an intermediate group LM, and a rear group LR, each of which includes one or more lens units. The front group LF consists of a first front lens unit LF1 with positive refractive power. The first front lens unit LF1 is fixed relative to the image plane during zooming. The intermediate group LM consists of, in order from the object side to the image side, a first intermediate lens unit LM1 with negative refractive power, a second intermediate lens unit LM2 with negative refractive power, and a third intermediate lens unit LM3 with positive refractive power. The first intermediate lens unit LM1, the second intermediate lens unit LM2, and the third intermediate lens unit LM3 move from the object side to the image side during zooming from the wide-angle end to the telephoto end. The rear group LR consists of, in order from the object side to the image side, a first rear lens unit LR1 to a fifth rear lens unit LR5 having positive, negative, positive, negative, and negative refractive powers. The first rear lens unit LR1 is fixed relative to the image plane during zooming. The first rear lens unit LR1 includes an aperture stop. The second rear lens unit LR2 moves during zooming. The second rear lens unit LR2 moves toward the image side during focusing from infinity to the close distance. The third rear lens unit LR3 is fixed relative to the image plane during zooming. The fourth rear lens unit LR4 moves during zooming. The fourth rear lens unit LR4 moves toward the image side during focusing from infinity to the close distance. The fifth rear lens unit LR5 is fixed relative to the image plane during zooming.

The zoom lens L0 according to each of Examples 2 to 5 consists of, in order from the object side to the image side, a front group LF, an intermediate group LM, and a rear group LR, each of which includes one or more lens units. The front group LF consists of a first front lens unit LF1 with positive refractive power. The first front lens unit LF1 is fixed relative to the image plane during zooming. The intermediate group LM consists of, in order from the object side, a first intermediate lens unit LM1 with negative refractive power, a second intermediate lens unit LM2 with negative refractive power, and a third intermediate lens unit LM3 with positive refractive power. The first intermediate lens unit LM1, the second intermediate lens unit LM2, and the third intermediate lens unit LM3 move from the object side to the image side during zooming from the wide-angle end to the telephoto end. The rear group LR consists of, in order from the object side to the image side, the first rear lens unit LR1 to the third rear lens unit LR3 having positive, negative, and positive refractive powers. The first rear lens unit LR1 is fixed relative to the image plane during zooming. The first rear lens unit LR1 includes the aperture stop. The second rear lens unit LR2 moves during zooming. The second rear lens unit LR2 moves toward the image side during focusing from infinity to the close distance. The third rear lens unit LR3 is fixed relative to the image plane during zooming.

The zoom lens L0 according to Example 6 consists of, in order from the object side to the image side, a front group LF, an intermediate group LM, and a rear group LR, each of which includes one or more lens units. The front group LF consists of a first front lens unit LF1 with positive refractive power. The first front lens unit LF1 is fixed relative to the image plane during zooming. The intermediate group LM consists of, in order from the object side, a first intermediate lens unit LM1 with negative refractive power, a second intermediate lens unit LM2 with negative refractive power, and a third intermediate lens unit LM3 with negative refractive power. The first intermediate lens unit LM1, the second intermediate lens unit LM2, and the third intermediate lens unit LM3 move from the object side to the image side during zooming from the wide-angle end to the telephoto end. The rear group LR consists of, in order from the object side to the image side, a first rear lens unit LR1 to a third rear lens unit LR3 having positive, negative, and positive refractive powers. The first rear lens unit LR1 is fixed relative to the image plane during zooming. The first rear lens unit LR1 includes the aperture stop. The second rear lens unit LR2 moves during zooming. The second rear lens unit LR2 moves toward the image side during focusing from infinity to the close distance. The third rear lens unit LR3 is fixed relative to the image plane during zooming.

In the zoom lenses L0 according to Examples 1 to 6, all surfaces with refractive power are refractive surfaces. Compared to lenses consisting of diffractive optical elements or reflective surfaces, it can easily achieve optical performance equal to or better than lenses consisting of diffractive optical elements or reflective surfaces, with lower manufacturing difficulty.

In the zoom lenses L0 according to Examples 1 to 6, no optical elements such as prisms that bend the optical path are used. The prism etc. that bends the optical path increases the thickness of the lens, and it becomes difficult to reduce the size.

A description will now be given of numerical values corresponding to Examples 1 to 6, respectively.

In the surface data for each numerical example, r represents a radius of curvature of each optical surface, and d (mm) represents an on-axis distance (distance on the optical axis) between m-th and (m+1)-th surfaces, where m is a surface number counted from the light incident side. nd represents a refractive index of each optical element for the d-line, and νd represents an Abbe number of each optical element for the d-line. The Abbe number νd of a material is expressed as follows:

$$v d = ( N d - 1 ) / ( NF - N C )$$

where Nd, NF, and NC are refractive indices for the d-line (587.6 nm), F-line (486.1 nm), and C-line (656.3 nm) in the Fraunhofer.

In each numerical example, d, focal length (mm), F-number, and half angle of view (°) are all values when the zoom lens L0 according to each example is in an in-focus state on an object at infinity. A “back focus (BF)” is a distance on the optical axis from the final surface (the lens surface closest to the image plane) of the zoom lens L0 to the paraxial image plane, expressed as an air-equivalent length. An “overall lens length” is a distance on the optical axis from the foremost surface (the lens surface closest to the object) of the zoom lens L0 to the final surface, plus the back focus. WIDE represents a wide-angle end, MIDDLE represents an intermediate zoom position, and TELE represents a telephoto end.

In a case where the optical surface is aspherical, an asterisk * is added to the right of the surface number. The aspheric shape is expressed as follows:

$$X = \frac{( \frac{{H}^{2}}{R} )}{1 + \sqrt{\{ 1 - ( 1 + K ) {( H / R )}^{2} \}}} + A 4 \cdot {H}^{4} + A 6 \cdot {H}^{6} + A 8 \cdot {H}^{8} + A 10 \cdot {H}^{10}$$

where X is a displacement amount from a surface vertex in the optical axis direction, H is a height from the optical axis in a direction orthogonal to the optical axis, R is a paraxial radius of curvature, K is a conic constant, and A4, A5, A6, A7, A8, A9, A10, A11, and A12 are the aspheric coefficients of each order.

“e±XX” in each aspheric coefficient means “×10^{±XX}.”

### Numerical Example 1

UNIT: mm
SURFACE DATA

| Surface | | | | | Effective |
|---|---|---|---|---|---|
| No. | r | d | nd | νd | Diameter |
| 1 | 262.061 | 2.00 | 1.74951 | 35.3 | 71.95 |
| 2 | 112.605 | 9.48 | 1.49700 | 81.5 | 70.42 |
| 3 | −460.620 | 0.20 | | | 69.99 |
| 4 | 80.743 | 8.75 | 1.49700 | 81.5 | 67.61 |
| 5 | 473.802 | (Variable) | | | 66.42 |
| 6 | 79.217 | 1.40 | 1.80400 | 46.5 | 43.59 |
| 7 | 40.318 | (Variable) | | | 40.28 |
| 8 | −95.544 | 1.40 | 1.59282 | 68.6 | 40.22 |
| 9 | 143.830 | (Variable) | | | 40.93 |
| 10 | 59.016 | 6.29 | 1.80518 | 25.4 | 42.35 |
| 11 | 3274.925 | 2.93 | | | 42.04 |
| 12 | −83.952 | 1.60 | 1.49700 | 81.5 | 41.99 |
| 13 | 142.209 | (Variable) | | | 42.15 |
| 14* | 80.299 | 5.50 | 1.58313 | 59.4 | 42.54 |
| 15* | −441.519 | 0.15 | | | 42.49 |
| 16 | 62.104 | 7.47 | 1.43387 | 95.1 | 41.88 |
| 17 | −116.621 | 3.26 | | | 41.27 |
| 18 (SP) | ∞ | 4.09 | | | 38.04 |
| 19 | −100.306 | 1.40 | 1.77047 | 29.7 | 36.51 |
| 20 | 55.864 | 5.93 | | | 35.48 |
| 21 | 74.214 | 1.20 | 1.85478 | 24.8 | 36.84 |
| 22 | 42.266 | 7.47 | 1.76385 | 48.5 | 36.55 |
| 23* | −194.403 | 0.48 | | | 36.41 |
| 24 | 70.089 | 5.10 | 1.61800 | 63.4 | 35.67 |
| 25 | −184.791 | (Variable) | | | 35.03 |
| 26 | 745.543 | 2.75 | 1.92286 | 20.9 | 32.98 |
| 27 | −150.403 | 1.00 | 1.61340 | 44.3 | 32.33 |
| 28 | 33.408 | (Variable) | | | 30.35 |
| 29 | 50.960 | 10.21 | 1.51633 | 64.1 | 40.08 |
| 30 | −57.713 | (Variable) | | | 40.13 |
| 31 | −129.079 | 1.30 | 1.90110 | 27.1 | 39.03 |
| 32 | 101.826 | (Variable) | | | 38.83 |
| 33 | 165.501 | 5.86 | 1.84666 | 23.8 | 41.04 |
| 34 | −87.663 | 12.99 | | | 41.11 |
| 35* | −28.324 | 2.10 | 1.58313 | 59.4 | 37.66 |
| 36* | −275.175 | (Variable) | | | 39.59 |
| Image Plane | ∞ | | | | |

ASPHERIC DATA
14th Surface
K = 0.00000e+00 A 4 = −1.35279e−06 A 6 = −1.41239e−10
A 8 = −1.79295e−12
15th Surface
K = 0.00000e+00 A 4 = −1.79535e−07 A 6 = −2.14412e−10
A 8 = −1.70807e−12
23rd Surface
K = 0.00000e+00 A 4 = 7.64577e−07 A 6 = 1.37775e−10
A 8 = −1.38956e−13
35th Surface
K = 0.00000e+00 A 4 = 1.21476e−05 A 6 = −1.50760e−08
A 8 = 1.75889e−11
A10 = 9.64191e−16
36th Surface
K = 0.00000e+00 A 4 = 4.88184e−06 A 6 = −1.70817e−08
A 8 = 9.50057e−12

VARIOUS DATA
ZOOM RATIO 1.90

| | WIDE | MIDDLE | TELE |
|---|---|---|---|
| Focal Length | 72.10 | 99.23 | 136.89 |
| Fno | 2.05 | 2.05 | 2.05 |
| Half Angle of View (°) | 16.70 | 12.30 | 8.98 |
| Image Height | 21.64 | 21.64 | 21.64 |
| Overall Lens Length | 211.33 | 211.33 | 211.33 |
| BF | 14.02 | 14.02 | 14.02 |
| d5 | 9.24 | 27.85 | 44.43 |
| d7 | 11.82 | 10.23 | 9.50 |
| d9 | 7.33 | 3.11 | 0.98 |
| d13 | 27.65 | 14.85 | 1.12 |
| d25 | 2.04 | 1.98 | 0.98 |
| d28 | 17.35 | 17.41 | 18.41 |
| d30 | 4.18 | 3.92 | 0.85 |
| d32 | 5.40 | 5.67 | 8.73 |
| d36 | 14.02 | 14.02 | 14.02 |
| Entrance Pupil-Position | 93.38 | 133.52 | 173.45 |
| Exit Pupil Position | −47.28 | −47.45 | −49.67 |
| Front Principal- | 80.67 | 72.56 | 16.10 |
| Point Position | | | |
| Rear Principal- | −58.08 | −85.21 | −122.87 |
| Point Position | | | |

ZOOM LENS UNIT DATA

| Lens | Starting | Focal | Lens Configuration |
|---|---|---|---|
| Unit | Surface | Length | Length |
| 1 | 1 | 146.81 | 20.43 |
| 2 | 6 | −103.79 | 1.40 |
| 3 | 8 | −96.63 | 1.40 |
| 4 | 10 | 206.56 | 10.82 |
| 5 | 14 | 49.56 | 42.05 |
| 6 | 26 | −66.67 | 3.75 |
| 7 | 29 | 54.15 | 10.21 |
| 8 | 31 | −63.00 | 1.30 |
| 9 | 33 | −25075.54 | 20.95 |

ZOOM LENS UNIT DATA

| Front Principal- | Rear Principal- |
|---|---|
| Point Position | Point Position |
| 5.72 | −7.81 |
| 1.61 | 0.82 |
| 0.35 | −0.53 |
| −13.45 | −19.69 |
| 20.90 | −18.79 |
| 2.31 | 0.25 |
| 3.26 | −3.69 |
| 0.38 | −0.30 |
| 6441.30 | 5110.94 |

SINGLE LENS DATA

| Lens | Starting Surface | Focal Length |
|---|---|---|
| 1 | 1 | −264.95 |
| 2 | 2 | 183.07 |
| 3 | 4 | 194.40 |
| 4 | 6 | −103.79 |
| 5 | 8 | −96.63 |
| 6 | 10 | 74.58 |
| 7 | 12 | −105.97 |
| 8 | 14 | 116.97 |
| 9 | 16 | 94.60 |
| 10 | 19 | −46.39 |
| 11 | 21 | −116.89 |
| 12 | 22 | 46.08 |
| 13 | 24 | 82.86 |
| 14 | 26 | 135.82 |
| 15 | 27 | −44.47 |
| 16 | 29 | 54.15 |
| 17 | 31 | −63.00 |
| 18 | 33 | 68.41 |
| 19 | 35 | −54.32 |

### Numerical Example 2

UNIT: mm
SURFACE DATA

| Surface | | | | | Effective |
|---|---|---|---|---|---|
| No. | r | d | nd | νd | Diameter |
| 1 | 361.011 | 6.57 | 1.48749 | 70.2 | 96.73 |
| 2 | −1485.054 | 0.20 | | | 96.32 |
| 3 | 160.947 | 9.95 | 1.43387 | 95.1 | 94.12 |
| 4 | 31391.523 | 33.74 | | | 93.01 |
| 5 | 120.834 | 10.19 | 1.43875 | 94.7 | 75.81 |
| 6 | −788.983 | 2.40 | 1.61340 | 44.3 | 74.21 |
| 7 | 128.256 | (Variable) | | | 70.69 |
| 8 | 143.575 | 1.80 | 1.49700 | 81.5 | 39.88 |
| 9 | 48.690 | (Variable) | | | 38.48 |
| 10 | −137.556 | 1.60 | 1.72916 | 54.1 | 38.29 |
| 11 | 226.174 | (Variable) | | | 38.60 |
| 12 | 78.992 | 3.44 | 1.85478 | 24.8 | 39.32 |
| 13 | 399.071 | 2.60 | | | 39.18 |
| 14 | −100.748 | 1.60 | 1.49700 | 81.5 | 39.16 |
| 15 | 215.566 | (Variable) | | | 39.48 |
| 16 | 99.030 | 4.66 | 1.49700 | 81.5 | 40.45 |
| 17 | −217.632 | 0.15 | | | 40.46 |
| 18 | 54.964 | 4.94 | 1.49700 | 81.5 | 40.03 |
| 19 | 369.405 | 3.20 | | | 39.51 |
| 20 (SP) | ∞ | 0.10 | | | 38.39 |
| 21 | 35.805 | 3.76 | 1.49700 | 81.5 | 36.29 |
| 22 | 60.656 | 2.00 | 1.72047 | 34.7 | 35.34 |
| 23 | 38.091 | 4.93 | | | 33.27 |
| 24 | 25878.787 | 1.60 | 1.83481 | 42.7 | 32.79 |
| 25 | 47.455 | 2.87 | | | 31.79 |
| 26 | 95.521 | 1.80 | 1.92119 | 24.0 | 32.04 |
| 27 | 57.392 | 4.34 | 1.49700 | 81.5 | 31.83 |
| 28 | −211.192 | 0.15 | | | 31.92 |
| 29 | 86.334 | 3.11 | 1.85150 | 40.8 | 31.97 |
| 30 | −578.932 | 0.49 | | | 31.75 |
| 31 | 48.486 | 3.18 | 1.51742 | 52.4 | 30.63 |
| 32 | 148.932 | (Variable) | | | 29.97 |
| 33 | −327.562 | 3.11 | 1.92286 | 20.9 | 27.61 |
| 34 | −84.741 | 0.14 | | | 27.01 |
| 35 | −97.830 | 1.30 | 1.90043 | 37.4 | 26.74 |
| 36 | 53.965 | (Variable) | | | 25.65 |
| 37 | 83.713 | 1.99 | 1.92286 | 20.9 | 44.99 |
| 38 | 55.434 | 9.43 | 1.66565 | 35.6 | 44.60 |
| 39 | −93.812 | 17.20 | | | 44.61 |
| 40 | −64.497 | 2.00 | 1.49700 | 81.5 | 39.16 |
| 41 | 197.784 | (Variable) | | | 39.19 |
| Image Plane | ∞ | | | | |

VARIOUS DATA
ZOOM RATIO 1.90

| | WIDE | MIDDLE | TELE |
|---|---|---|---|
| Focal Length | 205.00 | 282.33 | 389.99 |
| Fno | 4.10 | 4.10 | 4.10 |
| Half Angle of View (°) | 6.02 | 4.38 | 3.18 |
| Image Height | 21.64 | 21.64 | 21.64 |
| Overall Lens Length | 367.04 | 367.04 | 367.04 |
| BF | 40.00 | 40.00 | 40.00 |
| d7 | 48.74 | 72.22 | 94.04 |
| d9 | 9.75 | 7.30 | 8.47 |
| d11 | 13.15 | 7.13 | 0.99 |
| d15 | 32.86 | 17.85 | 1.00 |
| d32 | 4.98 | 5.40 | 3.54 |
| d36 | 67.03 | 66.60 | 68.47 |
| d41 | 40.00 | 40.00 | 40.00 |
| Entrance Pupil-Position | 343.05 | 437.50 | 530.25 |
| Exit Pupil Position | −128.35 | −127.79 | −130.22 |
| Front Principal- | 298.40 | 244.74 | 26.72 |
| Point Position | | | |
| Rear Principal- | −165.01 | −242.34 | −349.99 |
| Point Position | | | |

ZOOM LENS UNIT DATA

| Lens | Starting | Focal | Lens Configuration |
|---|---|---|---|
| Unit | Surface | Length | Length |
| 1 | 1 | 283.25 | 63.06 |
| 2 | 8 | −149.18 | 1.80 |
| 3 | 10 | −117.09 | 1.60 |
| 4 | 12 | 554.67 | 7.64 |
| 5 | 16 | 54.03 | 41.27 |
| 6 | 33 | −55.97 | 4.55 |
| 7 | 37 | 172.20 | 30.61 |

ZOOM LENS UNIT DATA

| Front Principal- | Rear Principal- |
|---|---|
| Point Position | Point Position |
| −23.47 | −69.53 |
| 1.83 | 0.62 |
| 0.35 | −0.57 |
| −21.54 | −26.09 |
| 14.64 | −22.56 |
| 2.20 | −0.23 |
| −34.06 | −49.05 |

SINGLE LENS DATA

| Lens | Starting Surface | Focal Length |
|---|---|---|
| 1 | 1 | 596.43 |
| 2 | 3 | 372.83 |
| 3 | 5 | 239.65 |
| 4 | 6 | −179.68 |
| 5 | 8 | −149.18 |
| 6 | 10 | −117.09 |
| 7 | 12 | 114.65 |
| 8 | 14 | −137.92 |
| 9 | 16 | 137.61 |
| 10 | 18 | 129.25 |
| 11 | 21 | 167.43 |
| 12 | 22 | −147.59 |
| 13 | 24 | −56.95 |
| 14 | 26 | −159.70 |
| 15 | 27 | 91.29 |
| 16 | 29 | 88.42 |
| 17 | 31 | 137.46 |
| 18 | 33 | 123.11 |
| 19 | 35 | −38.47 |
| 20 | 37 | −184.03 |
| 21 | 38 | 53.70 |
| 22 | 40 | −97.61 |

### Numerical Example 3

UNIT: mm
SURFACE DATA

| Surface | | | | | Effective |
|---|---|---|---|---|---|
| No. | r | d | nd | νd | Diameter |
| 1 | 158.503 | 11.23 | 1.49700 | 81.5 | 95.12 |
| 2 | −656.114 | 28.23 | | | 94.66 |
| 3 | 121.416 | 10.82 | 1.43387 | 95.1 | 80.38 |
| 4 | −496.455 | 0.55 | | | 79.23 |
| 5 | −404.867 | 2.40 | 1.61340 | 44.3 | 79.07 |
| 6 | 203.113 | (Variable) | | | 75.98 |
| 7 | 178.872 | 1.80 | 1.49700 | 81.5 | 42.18 |
| 8 | 44.729 | (Variable) | | | 40.35 |
| 9 | −82.215 | 1.60 | 1.59282 | 68.6 | 40.23 |
| 10 | 433.502 | (Variable) | | | 41.02 |
| 11 | 77.860 | 2.63 | 1.92286 | 20.9 | 42.19 |
| 12 | 143.615 | (Variable) | | | 42.06 |
| 13 | 100.199 | 5.29 | 1.43875 | 94.7 | 43.47 |
| 14 | −196.438 | 0.20 | | | 43.39 |
| 15 | 99.801 | 3.95 | 1.49700 | 81.5 | 42.78 |
| 16 | −1602.137 | 6.72 | | | 42.40 |
| 17 (SP) | ∞ | 0.10 | | | 39.66 |
| 18 | 78.912 | 4.33 | 1.95375 | 32.3 | 38.66 |
| 19 | 89.393 | 3.55 | | | 36.92 |
| 20 | −116.222 | 2.00 | 1.83481 | 42.7 | 36.85 |
| 21 | 67.734 | 3.05 | | | 36.24 |
| 22 | 186.228 | 1.80 | 1.92286 | 20.9 | 36.65 |
| 23 | 75.596 | 5.91 | 1.49700 | 81.5 | 36.81 |
| 24 | −90.585 | 0.15 | | | 37.16 |
| 25 | 93.922 | 3.70 | 1.90366 | 31.3 | 37.59 |
| 26 | −427.193 | 3.95 | | | 37.39 |
| 27 | −60.792 | 1.80 | 1.92286 | 20.9 | 36.87 |
| 28 | −76.936 | 6.49 | | | 37.19 |
| 29 | −963.152 | 3.91 | 1.51633 | 64.1 | 35.38 |
| 30 | −63.777 | (Variable) | | | 35.18 |
| 31 | −492.111 | 3.00 | 1.92286 | 20.9 | 30.20 |
| 32 | −63.830 | 1.30 | 1.80000 | 29.8 | 29.84 |
| 33 | 61.152 | (Variable) | | | 28.45 |
| 34 | 91.134 | 2.00 | 1.90366 | 31.3 | 43.77 |
| 35 | 53.201 | 8.77 | 1.66565 | 35.6 | 43.32 |
| 36 | −109.742 | 15.96 | | | 43.31 |
| 37 | −81.075 | 2.00 | 1.49700 | 81.5 | 38.88 |
| 38 | 138.155 | (Variable) | | | 38.77 |
| Image Plane | ∞ | | | | |

VARIOUS DATA
ZOOM RATIO 1.90

| | WIDE | MIDDLE | TELE |
|---|---|---|---|
| Focal Length | 205.00 | 281.99 | 389.98 |
| Fno | 4.10 | 4.06 | 4.10 |
| Half Angle of View (°) | 6.02 | 4.39 | 3.18 |
| Image Height | 21.64 | 21.64 | 21.64 |
| Overall Lens Length | 367.20 | 367.20 | 367.20 |
| BF | 41.25 | 41.25 | 41.25 |
| d6 | 37.46 | 64.41 | 88.05 |
| d8 | 19.13 | 10.81 | 12.18 |
| d10 | 13.11 | 8.82 | 1.07 |
| d12 | 32.76 | 18.42 | 1.16 |
| d30 | 10.13 | 7.07 | 0.99 |
| d33 | 64.17 | 67.23 | 73.30 |
| d38 | 41.25 | 41.25 | 41.25 |
| Entrance Pupil-Position | 274.06 | 369.25 | 471.29 |
| Exit Pupil Position | −119.92 | −122.98 | −129.00 |
| Front Principal- | 218.32 | 167.07 | −32.00 |
| Point Position | | | |
| Rear Principal- | −163.74 | −240.74 | −348.73 |
| Point Position | | | |

ZOOM LENS UNIT DATA

| Lens | Starting | Focal | Lens Configuration |
|---|---|---|---|
| Unit | Surface | Length | Length |
| 1 | 1 | 247.51 | 53.24 |
| 2 | 7 | −120.54 | 1.80 |
| 3 | 9 | −116.44 | 1.60 |
| 4 | 11 | 180.80 | 2.63 |
| 5 | 13 | 72.38 | 56.89 |
| 6 | 31 | −76.54 | 4.30 |
| 7 | 34 | 266.03 | 28.73 |

ZOOM LENS UNIT DATA

| Front Principal- | Rear Principal- |
|---|---|
| Point Position | Point Position |
| −6.81 | −49.36 |
| 1.61 | 0.40 |
| 0.16 | −0.84 |
| −1.59 | −2.93 |
| 29.36 | −26.76 |
| 2.05 | −0.22 |
| −48.74 | −60.83 |

SINGLE LENS DATA

| Lens | Starting Surface | Focal Length |
|---|---|---|
| 1 | 1 | 258.05 |
| 2 | 3 | 226.05 |
| 3 | 5 | −220.17 |
| 4 | 7 | −120.54 |
| 5 | 9 | −116.44 |
| 6 | 11 | 180.80 |
| 7 | 13 | 152.06 |
| 8 | 15 | 189.18 |
| 9 | 18 | 587.36 |
| 10 | 20 | −51.01 |
| 11 | 22 | −138.97 |
| 12 | 23 | 83.90 |
| 13 | 25 | 85.49 |
| 14 | 27 | −331.70 |
| 15 | 29 | 132.08 |
| 16 | 31 | 79.21 |
| 17 | 32 | −38.86 |
| 18 | 34 | −145.07 |
| 19 | 35 | 55.01 |
| 20 | 37 | −102.49 |

### Numerical Example 4

UNIT: mm
SURFACE DATA

| Surface | | | | | Effective |
|---|---|---|---|---|---|
| No. | r | d | nd | νd | Diameter |
| 1 | 224.467 | 6.23 | 1.48749 | 70.2 | 74.94 |
| 2 | −1478.792 | 0.20 | | | 74.39 |
| 3 | 106.561 | 9.39 | 1.43875 | 94.7 | 72.04 |
| 4 | 56342.074 | 0.50 | | | 70.63 |
| 5 | 92.631 | 9.59 | 1.43875 | 94.7 | 66.22 |
| 6 | −2496.668 | 2.40 | 1.61340 | 44.3 | 63.95 |
| 7 | 101.371 | (Variable) | | | 59.74 |
| 8 | 167.578 | 0.90 | 1.83481 | 42.7 | 34.58 |
| 9 | 41.686 | (Variable) | | | 32.40 |
| 10 | −58.759 | 0.90 | 1.49700 | 81.5 | 30.38 |
| 11 | 165.505 | (Variable) | | | 31.17 |
| 12 | 67.095 | 4.07 | 1.80518 | 25.5 | 32.16 |
| 13 | −276.671 | 1.64 | | | 32.17 |
| 14 | −68.524 | 0.90 | 1.49700 | 81.5 | 32.15 |
| 15 | 117.733 | (Variable) | | | 32.56 |
| 16 (SP) | ∞ | 1.00 | | | 33.16 |
| 17 | 158.836 | 3.36 | 1.49700 | 81.5 | 33.73 |
| 18 | −145.337 | 0.15 | | | 33.91 |
| 19 | 67.714 | 3.34 | 1.49700 | 81.5 | 34.15 |
| 20 | 470.676 | 2.50 | | | 33.97 |
| 21 | 42.015 | 3.27 | 1.49700 | 81.5 | 33.13 |
| 22 | 85.105 | 8.21 | | | 32.59 |
| 23 | 305.660 | 1.60 | 1.80610 | 33.3 | 29.98 |
| 24 | 42.602 | 8.95 | | | 29.04 |
| 25 | 99.947 | 1.80 | 1.80810 | 22.8 | 30.03 |
| 26 | 50.437 | 4.56 | 1.49700 | 81.5 | 29.84 |
| 27 | −158.338 | 0.15 | | | 29.92 |
| 28 | 65.861 | 3.31 | 1.59270 | 35.3 | 29.88 |
| 29 | −601.824 | 0.63 | | | 29.62 |
| 30 | 59.167 | 3.46 | 1.49700 | 81.5 | 28.87 |
| 31 | 473.594 | (Variable) | | | 28.60 |
| 32 | −172.382 | 3.28 | 1.92286 | 20.9 | 26.77 |
| 33 | −61.471 | 0.20 | | | 26.72 |
| 34 | −64.352 | 1.30 | 1.87070 | 40.7 | 26.59 |
| 35 | 51.203 | (Variable) | | | 26.40 |
| 36 | 146.103 | 7.32 | 1.57099 | 50.8 | 42.46 |
| 37 | −59.877 | 20.65 | | | 42.71 |
| 38 | −55.103 | 2.00 | 1.75500 | 52.3 | 37.95 |
| 39 | −133.162 | (Variable) | | | 38.69 |
| Image Plane | ∞ | | | | |

VARIOUS DATA
ZOOM RATIO 4.03

| | WIDE | MIDDLE | TELE |
|---|---|---|---|
| Focal Length | 72.15 | 144.77 | 290.97 |
| Fno | 3.97 | 4.07 | 4.10 |
| Half Angle of View (°) | 16.69 | 8.50 | 4.25 |
| Image Height | 21.64 | 21.64 | 21.64 |
| Overall Lens Length | 289.03 | 289.03 | 289.03 |
| BF | 39.99 | 39.99 | 39.99 |
| d7 | 7.05 | 43.72 | 71.72 |
| d9 | 10.19 | 7.27 | 10.21 |
| d11 | 13.55 | 6.99 | 1.10 |
| d15 | 55.36 | 28.16 | 3.13 |
| d31 | 3.18 | 8.85 | 10.87 |
| d35 | 41.95 | 36.27 | 34.25 |
| d39 | 39.99 | 39.99 | 39.99 |
| Entrance Pupil-Position | 93.14 | 198.70 | 315.76 |
| Exit Pupil Position | −130.27 | −116.95 | −112.54 |
| Front Principal- | 134.72 | 209.92 | 51.65 |
| Point Position | | | |
| Rear Principal- | −32.16 | −104.78 | −250.98 |
| Point Position | | | |

ZOOM LENS UNIT DATA

| Lens | Starting | Focal | Lens Configuration |
|---|---|---|---|
| Unit | Surface | Length | Length |
| 1 | 1 | 172.09 | 28.31 |
| 2 | 8 | −66.69 | 0.90 |
| 3 | 10 | −87.13 | 0.90 |
| 4 | 12 | 251.99 | 6.62 |
| 5 | 16 | 48.69 | 46.29 |
| 6 | 32 | −47.61 | 4.78 |
| 7 | 36 | 132.22 | 29.97 |

ZOOM LENS UNIT DATA

| Front Principal- | Rear Principal- |
|---|---|
| Point Position | Point Position |
| −7.30 | −25.08 |
| 0.66 | 0.16 |
| 0.16 | −0.44 |
| −10.25 | −14.17 |
| 25.89 | −23.88 |
| 2.11 | −0.47 |
| −18.93 | −39.19 |

SINGLE LENS DATA

| Lens | Starting Surface | Focal Length |
|---|---|---|
| 1 | 1 | 400.25 |
| 2 | 3 | 243.32 |
| 3 | 5 | 203.80 |
| 4 | 6 | −158.76 |
| 5 | 8 | −66.69 |
| 6 | 10 | −87.13 |
| 7 | 12 | 67.42 |
| 8 | 14 | −87.01 |
| 9 | 17 | 153.27 |
| 10 | 19 | 158.70 |
| 11 | 21 | 162.86 |
| 12 | 23 | −61.58 |
| 13 | 25 | −128.08 |
| 14 | 26 | 77.53 |
| 15 | 28 | 100.34 |
| 16 | 30 | 135.67 |
| 17 | 32 | 102.08 |
| 18 | 34 | −32.58 |
| 19 | 36 | 75.35 |
| 20 | 38 | −125.89 |

### Numerical Example 5

UNIT: mm
SURFACE DATA

| Surface | | | | | Effective |
|---|---|---|---|---|---|
| No. | r | d | nd | νd | Diameter |
| 1 | 302.311 | 7.55 | 1.48749 | 70.2 | 90.77 |
| 2 | −710.185 | 0.20 | | | 90.50 |
| 3 | 124.076 | 10.99 | 1.43875 | 94.7 | 88.43 |
| 4 | 3241.233 | 24.75 | | | 87.25 |
| 5 | 106.160 | 9.87 | 1.49700 | 81.5 | 70.87 |
| 6 | −1100.392 | 2.40 | 1.78590 | 44.2 | 68.94 |
| 7 | 109.956 | (Variable) | | | 65.17 |
| 8 | 138.206 | 1.80 | 1.77250 | 49.6 | 36.68 |
| 9 | 62.038 | (Variable) | | | 35.64 |
| 10 | −127.548 | 1.60 | 1.72916 | 54.7 | 35.25 |
| 11 | 106.526 | (Variable) | | | 35.46 |
| 12 | 77.322 | 4.95 | 1.75520 | 27.5 | 36.30 |
| 13 | −158.781 | 1.01 | | | 36.26 |
| 14 | −89.784 | 1.60 | 1.65160 | 58.5 | 36.22 |
| 15 | 168.194 | (Variable) | | | 36.38 |
| 16 | 83.693 | 4.67 | 1.49700 | 81.5 | 36.80 |
| 17 | −175.796 | 0.15 | | | 36.78 |
| 18 | 80.974 | 3.29 | 1.49700 | 81.5 | 36.41 |
| 19 | 838.241 | 0.15 | | | 36.09 |
| 20 | 54.407 | 5.40 | 1.49700 | 81.5 | 35.17 |
| 21 | −250.393 | 2.00 | 1.83400 | 37.2 | 34.35 |
| 22 | 111.236 | 23.11 | | | 33.10 |
| 23 (SP) | ∞ | 4.03 | | | 25.46 |
| 24 | 28862.747 | 1.60 | 1.85150 | 40.8 | 24.06 |
| 25 | 39.576 | 3.33 | | | 23.43 |
| 26 | 65.096 | 1.80 | 1.92286 | 20.9 | 23.91 |
| 27 | 38.527 | 3.32 | 1.49700 | 81.5 | 23.69 |
| 28 | −5353.836 | 0.15 | | | 23.80 |
| 29 | 65.866 | 2.65 | 1.80000 | 29.8 | 23.93 |
| 30 | −463.819 | 0.99 | | | 23.78 |
| 31 | 31.610 | 4.21 | 1.51742 | 52.4 | 23.02 |
| 32 | −514.608 | (Variable) | | | 22.23 |
| 33 | 166.520 | 1.20 | 2.00069 | 25.5 | 18.86 |
| 34 | 28.095 | 2.63 | | | 17.93 |
| 35 | −45.099 | 1.20 | 1.75500 | 52.3 | 17.90 |
| 36 | 40.087 | 3.54 | 1.80518 | 25.4 | 18.26 |
| 37 | −65.948 | (Variable) | | | 18.44 |
| 38 | 42.326 | 2.00 | 1.94594 | 18.0 | 22.16 |
| 39 | 30.021 | 6.20 | 1.66565 | 35.6 | 21.89 |
| 40 | −32.066 | 0.55 | | | 21.90 |
| 41 | −30.868 | 1.50 | 1.53775 | 74.7 | 21.63 |
| 42 | 41.432 | (Variable) | | | 21.41 |
| Image Plane | ∞ | | | | |

VARIOUS DATA
ZOOM RATIO 3.28

| | WIDE | MIDDLE | TELE |
|---|---|---|---|
| Focal Length | 180.01 | 325.22 | 589.97 |
| Fno | 6.50 | 6.50 | 6.50 |
| Half Angle of View (°) | 6.85 | 3.81 | 2.10 |
| Image Height | 21.64 | 21.64 | 21.64 |
| Overall Lens Length | 351.92 | 351.92 | 351.92 |
| BF | 99.92 | 99.92 | 99.92 |
| d7 | 4.44 | 46.31 | 80.65 |
| d9 | 5.84 | 5.84 | 7.14 |
| d11 | 13.31 | 6.08 | 1.80 |
| d15 | 66.99 | 32.35 | 1.00 |
| d32 | 2.09 | 4.85 | 3.27 |
| d37 | 12.95 | 10.19 | 11.76 |
| d42 | 99.92 | 99.92 | 99.92 |
| Entrance Pupil-Position | 201.46 | 405.20 | 744.92 |
| Exit Pupil Position | −39.71 | −37.37 | −38.71 |
| Front Principal- | 149.40 | −39.99 | −1175.92 |
| Point Position | | | |
| Rear Principal- | −80.09 | −225.31 | −490.05 |
| Point Position | | | |

ZOOM LENS UNIT DATA

| Lens | Starting | Focal | Lens Configuration |
|---|---|---|---|
| Unit | Surface | Length | Length |
| 1 | 1 | 248.74 | 55.76 |
| 2 | 8 | −147.23 | 1.80 |
| 3 | 10 | −79.38 | 1.60 |
| 4 | 12 | 266.20 | 7.56 |
| 5 | 16 | 54.09 | 60.85 |
| 6 | 33 | −31.78 | 8.56 |
| 7 | 38 | 198.65 | 10.25 |

ZOOM LENS UNIT DATA

| Front Principal- | Rear Principal- |
|---|---|
| Point Position | Point Position |
| −31.78 | −66.67 |
| 1.86 | 0.84 |
| 0.50 | −0.42 |
| −8.75 | −13.11 |
| 48.34 | −39.11 |
| −0.11 | −6.25 |
| −16.61 | −21.11 |

SINGLE LENS DATA

| Lens | Starting Surface | Focal Length |
|---|---|---|
| 1 | 1 | 436.04 |
| 2 | 3 | 293.74 |
| 3 | 5 | 195.34 |
| 4 | 6 | −127.09 |
| 5 | 8 | −147.23 |
| 6 | 10 | −79.38 |
| 7 | 12 | 69.48 |
| 8 | 14 | −89.62 |
| 9 | 16 | 114.77 |
| 10 | 18 | 180.09 |
| 11 | 20 | 90.46 |
| 12 | 21 | −92.12 |
| 13 | 24 | −46.54 |
| 14 | 26 | −105.72 |
| 15 | 27 | 76.98 |
| 16 | 29 | 72.26 |
| 17 | 31 | 57.71 |
| 18 | 33 | −33.92 |
| 19 | 35 | −27.94 |
| 20 | 36 | 31.43 |
| 21 | 38 | −118.53 |
| 22 | 39 | 24.26 |
| 23 | 41 | −32.66 |

### Numerical Example 6

UNIT: mm
SURFACE DATA

| Surface | | | | | Effective |
|---|---|---|---|---|---|
| No. | r | d | nd | νd | Diameter |
| 1 | 291.195 | 5.68 | 1.48749 | 70.2 | 86.35 |
| 2 | ∞ | 0.20 | | | 85.71 |
| 3 | 138.423 | 9.37 | 1.43387 | 95.1 | 83.16 |
| 4 | ∞ | 46.70 | | | 81.94 |
| 5 | 85.483 | 9.89 | 1.43875 | 94.7 | 59.73 |
| 6 | −555.465 | 2.40 | 1.61340 | 44.3 | 57.82 |
| 7 | 83.239 | (Variable) | | | 54.42 |
| 8 | 138.233 | 3.00 | 1.80518 | 25.5 | 39.67 |
| 9 | 189.316 | 0.20 | | | 38.92 |
| 10 | 121.944 | 2.00 | 1.48749 | 70.2 | 38.66 |
| 11 | 43.718 | (Variable) | | | 37.07 |
| 12 | −129.186 | 2.00 | 1.65160 | 58.5 | 36.70 |
| 13 | 227.142 | 0.20 | | | 36.99 |
| 14 | 70.540 | 3.50 | 1.90110 | 27.1 | 37.44 |
| 15 | 132.369 | (Variable) | | | 37.11 |
| 16 | −82.573 | 1.60 | 1.49700 | 81.5 | 36.98 |
| 17 | 296.509 | (Variable) | | | 37.58 |
| 18 | 120.012 | 3.87 | 1.49700 | 81.5 | 38.13 |
| 19 | −221.000 | 0.15 | | | 38.24 |
| 20 | 65.531 | 3.80 | 1.49700 | 81.5 | 38.33 |
| 21 | 322.439 | 8.24 | | | 38.05 |
| 22 (SP) | ∞ | 0.22 | | | 36.37 |
| 23 | 37.108 | 3.67 | 1.49700 | 81.5 | 35.34 |
| 24 | 47.195 | 2.00 | 1.72047 | 34.7 | 34.16 |
| 25 | 45.919 | 3.69 | | | 33.16 |
| 26 | 243.949 | 1.60 | 1.83481 | 42.7 | 32.75 |
| 27 | 45.084 | 3.06 | | | 31.74 |
| 28 | 98.030 | 1.80 | 1.92119 | 24.0 | 31.97 |
| 29 | 57.965 | 4.19 | 1.49700 | 81.5 | 31.76 |
| 30 | −238.013 | 0.15 | | | 31.84 |
| 31 | 87.164 | 3.06 | 1.85150 | 40.8 | 31.89 |
| 32 | −628.278 | 0.50 | | | 31.67 |
| 33 | 54.225 | 2.99 | 1.60311 | 60.6 | 30.68 |
| 34 | 138.135 | (Variable) | | | 29.99 |
| 35 | −637.126 | 3.23 | 1.92286 | 20.9 | 27.96 |
| 36 | −90.315 | 0.23 | | | 27.34 |
| 37 | −99.554 | 1.30 | 1.91082 | 35.2 | 27.03 |
| 38 | 57.256 | (Variable) | | | 25.97 |
| 39 | 99.439 | 2.00 | 1.92286 | 20.9 | 42.70 |
| 40 | 70.070 | 7.37 | 1.66565 | 35.6 | 42.52 |
| 41 | −103.243 | 17.95 | | | 42.57 |
| 42 | −73.912 | 2.00 | 1.49700 | 81.5 | 38.41 |
| 43 | 235.759 | (Variable) | | | 38.54 |
| Image Plane | ∞ | | | | |

VARIOUS DATA
ZOOM RATIO 1.89

| | WIDE | MIDDLE | TELE |
|---|---|---|---|
| Focal Length | 180.01 | 247.34 | 340.94 |
| Fno | 4.10 | 4.10 | 4.10 |
| Half Angle of View (°) | 6.85 | 5.00 | 3.63 |
| Image Height | 21.64 | 21.64 | 21.64 |
| Overall Lens Length | 350.00 | 350.00 | 350.00 |
| BF | 40.69 | 40.69 | 40.69 |
| d7 | 6.30 | 33.12 | 54.08 |
| d11 | 19.91 | 13.60 | 10.76 |
| d15 | 15.00 | 8.74 | 10.29 |
| d17 | 35.00 | 20.74 | 1.08 |
| d34 | 3.70 | 4.24 | 4.89 |
| d38 | 65.60 | 65.06 | 64.41 |
| d43 | 40.69 | 40.69 | 40.69 |
| Entrance Pupil-Position | 300.58 | 390.67 | 475.99 |
| Exit Pupil Position | −122.35 | −121.77 | −121.08 |
| Front Principal- | 281.84 | 261.45 | 98.36 |
| Point Position | | | |
| Rear Principal- | −139.32 | −206.65 | −300.26 |
| Point Position | | | |

ZOOM LENS UNIT DATA

| Lens | Starting | Focal | Lens Configuration |
|---|---|---|---|
| Unit | Surface | Length | Length |
| 1 | 1 | 289.99 | 74.25 |
| 2 | 8 | −185.70 | 5.20 |
| 3 | 12 | −538.93 | 5.70 |
| 4 | 16 | −129.77 | 1.60 |
| 5 | 18 | 51.40 | 42.99 |
| 6 | 35 | −61.44 | 4.76 |
| 7 | 39 | 190.70 | 29.31 |

ZOOM LENS UNIT DATA

| Front Principal- | Rear Principal- |
|---|---|
| Point Position | Point Position |
| −51.16 | −96.57 |
| 6.57 | 3.25 |
| 3.99 | 0.76 |
| 0.23 | −0.83 |
| 17.61 | −22.34 |
| 2.54 | −0.04 |
| −33.10 | −48.96 |

SINGLE LENS DATA

| Lens | Starting Surface | Focal Length |
|---|---|---|
| 1 | 1 | 597.34 |
| 2 | 3 | 319.04 |
| 3 | 5 | 169.65 |
| 4 | 6 | −117.85 |
| 5 | 8 | 620.01 |
| 6 | 10 | −140.98 |
| 7 | 12 | −126.10 |
| 8 | 14 | 163.22 |
| 9 | 16 | −129.77 |
| 10 | 18 | 157.08 |
| 11 | 20 | 164.68 |
| 12 | 23 | 311.69 |
| 13 | 24 | −6856.10 |
| 14 | 26 | −66.49 |
| 15 | 28 | −157.35 |
| 16 | 29 | 94.23 |
| 17 | 31 | 90.07 |
| 18 | 33 | 146.05 |
| 19 | 35 | 113.71 |
| 20 | 37 | −39.75 |
| 21 | 39 | −265.76 |
| 22 | 40 | 63.79 |
| 23 | 42 | −112.98 |

Table 1 below summarizes various values in each numerical example.

TABLE 1

| | EX. 1 | EX. 2 | EX. 3 | EX. 4 | EX. 5 | EX. 6 |
|---|---|---|---|---|---|---|
| TLM1/fLF1 | 0.010 | 0.006 | 0.007 | 0.006 | 0.007 | 0.018 |
| TLM2/fLF1 | 0.010 | 0.006 | 0.006 | 0.005 | 0.006 | 0.020 |
| fLF1/ft | 1.072 | 0.726 | 0.635 | 0.591 | 0.422 | 0.851 |
| fw/fLM1 | −0.696 | −1.374 | −1.701 | −1.082 | −1.223 | −0.969 |
| fw/fLM2 | −0.746 | −1.751 | −1.761 | −0.828 | −2.268 | −0.334 |
| fw/fLM3 | 0.349 | 0.370 | 1.134 | 0.286 | 0.676 | −1.387 |
| fw/fLR1 | 1.455 | 3.794 | 2.832 | 1.482 | 3.328 | 3.502 |
| MLM1/fLF1 | 0.240 | 0.160 | 0.204 | 0.376 | 0.306 | 0.165 |
| MLM2/fLF1 | 0.224 | 0.155 | 0.176 | 0.376 | 0.312 | 0.133 |
| MLM3/fLF1 | 0.181 | 0.112 | 0.128 | 0.304 | 0.265 | 0.117 |
| β LRw | −0.490 | −0.883 | −0.584 | −0.912 | −1.239 | −1.072 |
| β LRt/β LRw | 0.859 | 0.937 | 0.611 | 1.340 | 1.071 | 1.041 |
| β LMt | −2.215 | −1.665 | −4.416 | −1.383 | −1.788 | −1.053 |
| BFw/fw | 0.194 | 0.195 | 0.201 | 0.554 | 0.555 | 0.226 |
| Lt/ft | 1.544 | 0.941 | 0.942 | 0.993 | 0.596 | 1.027 |

### Image Pickup Apparatus

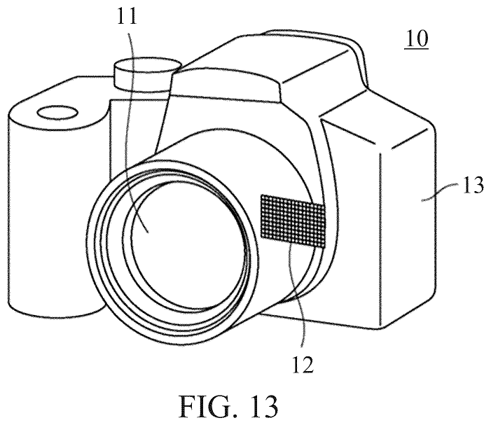

Referring now to FIG. 13, a description will be given of an example of a digital still camera (image pickup apparatus) using the zoom lens L0 according to the present disclosure as its imaging optical system. In FIG. 13, reference numeral 10 denotes a camera body, and reference numeral 11 denotes an imaging optical system that includes any of the zoom lenses L0 according to Examples 1 to 6. The imaging optical system 11 and the camera body 10 may be integrated or detachable. Reference numeral 12 denotes a solid-state image sensor (photoelectric conversion element) such as a CCD sensor or CMOS sensor built into the camera body 10 that receives and photoelectrically converts the optical image formed by the imaging optical system 11. The camera body 10 may be a so-called single-lens reflex camera with a quick-turn mirror, or a so-called mirrorless camera without a quick-turn mirror.

Applying the zoom lens L0 according to the present disclosure to an image pickup apparatus, such as a digital still camera, can provide an image pickup apparatus having a compact lens.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-031312, filed on Feb. 28, 2025, and which is hereby incorporated by reference herein in its entirety.

What is claimed is:

1. A zoom lens comprising, in order from an object side to an image side:
a front group, an intermediate group, and a rear group, each of which includes one or more lens units,
wherein each distance between adjacent lens units changes during zooming,
wherein the front group consists of a first front lens unit with positive refractive power,
wherein the first front lens unit is fixed relative to an image plane during zooming,
wherein the intermediate group consists of, in order from the object side to the image side, a first intermediate lens unit with negative refractive power, a second intermediate lens unit with negative refractive power, and a third intermediate lens unit,
wherein the third intermediate lens unit moves from the object side to the image side during zooming from a wide-angle end to a telephoto end, and
wherein the following inequalities are satisfied:
$$0.001 < TLM 1 / fLF 1 < 0 \text{.025}$$
$$0.001 < TLM 2 / fLF 1 < 0 \text{.022}$$
$$0.1 < MLM 1 / fLF 1 < 0.39$$
where fLF1 is a focal length of the first front lens unit, TLM1 is a distance on an optical axis from a lens surface closest to an object in the first intermediate lens unit to a lens surface closest to the image plane in the first intermediate lens unit, TLM2 is a distance on the optical axis from a lens surface closest to the object in the second intermediate lens unit to a lens surface closest to the image plane in the second intermediate lens unit, and MLM1 is a moving amount, where the moving amount toward the object side is positive, of the first intermediate lens unit during zooming from the wide-angle end to the telephoto end.

2. The zoom lens according to claim 1, wherein a first rear lens unit, disposed closest to the object among lens units included in the rear group, has positive refractive power.

3. The zoom lens according to claim 1, wherein a first rear lens unit, disposed closest to the object among lens units included in the rear group, is fixed relative to the image plane during zooming.

4. The zoom lens according to claim 1, wherein a first rear lens unit, disposed closest to the object among lens units included in the rear group, includes an aperture stop.

5. The zoom lens according to claim 1, wherein a second rear lens unit, disposed on the image side of and adjacent to a first rear lens unit disposed closest to the object among lens units included in the rear group, moves during zooming.

6. The zoom lens according to claim 1, wherein a second rear lens unit, disposed on the image side of and adjacent to a first rear lens unit disposed closest to the object among lens units included in the rear group, moves during focusing.

7. The zoom lens according to claim 1, wherein a second rear lens unit, disposed on the image side of and adjacent to a first rear lens unit disposed closest to the object among lens units included in the rear group, has negative refractive power.

8. The zoom lens according to claim 1, wherein a lens unit disposed closest to the image plane is fixed relative to the image plane during zooming.

9. The zoom lens according to claim 1, wherein the front group and the intermediate group are fixed relative to the image plane during focusing.

10. The zoom lens according to claim 1, wherein a first rear lens unit, disposed closest to the object among lens units included in the rear group, has a positive lens closest to the object.

11. The zoom lens according to claim 1, wherein the following inequality is satisfied:
$$0. 2 < fLF 1 / ft < 2.1$$
where ft is a focal length of the zoom lens in an in-focus state on an object at infinity at the telephoto end.

12. The zoom lens according to claim 1, wherein the following inequality is satisfied:
$$- 3.4 < fw / fLM 1 < - 0.3$$
where fw is a focal length of the zoom lens in an in-focus state on an object at infinity at the wide-angle end, and fLM1 is a focal length of the first intermediate lens unit.

13. The zoom lens according to claim 1, wherein the following inequality is satisfied:
$$- 4.5 < fw / fLM 2 < - 0.2$$
where fw is a focal length of the zoom lens in an in-focus state on an object at infinity at the wide-angle end, and fLM2 is a focal length of the second intermediate lens unit.

14. The zoom lens according to claim 1, wherein the following inequality is satisfied:
$$- 2.8 < fw / fLM 3 < 2.3$$
where fw is a focal length of the zoom lens in an in-focus state on an object at infinity at the wide-angle end, and fLM3 is a focal length of the third intermediate lens unit.

15. The zoom lens according to claim 1, wherein the following inequality is satisfied:
$$0.7 < fw / fLR 1 < 7.6$$
where fw is a focal length of the zoom lens in an in-focus state on an object at infinity at the wide-angle end, and fLR1 is a focal length of a first rear lens unit disposed closest to the object among lens units included in the rear groups.

16. The zoom lens according to claim 1, wherein the following inequality is satisfied:
$$0.1 < MLM 2 / fLF 1 < 0.8$$
where MLM2 is a moving amount, where the moving amount toward the object side is positive, of the second intermediate lens unit during zooming from the wide-angle end to the telephoto end.

17. The zoom lens according to claim 1, wherein the following inequality is satisfied:
$$0.1 < MLM 3 / fLF 1 < 0.6$$
where MLM3 is a moving amount, where the moving amount toward the object side is positive, of the third intermediate lens unit during zooming from the wide-angle end to the telephoto end.

18. The zoom lens according to claim 1, wherein the following inequality is satisfied:
$$- 2.5 < β LRw < - 0.2$$
where βLRw is a combined lateral magnification of the rear group at the wide-angle end.

19. The zoom lens according to claim 1, wherein the following inequality is satisfied:
$$0.3 < β LRt / β LRw < 2.7$$
where βLRw is a combined lateral magnification of the rear group at the wide-angle end, and βLRt is a combined lateral magnification of the rear group at the telephoto end.

20. The zoom lens according to claim 1, wherein the following inequality is satisfied:
$$- 8.8 < β LMt < - 0.5$$
where βLMt is a combined lateral magnification of the intermediate group at the telephoto end.

21. The zoom lens according to claim 1, wherein the following inequality is satisfied:
$$0.1 < BFw / fw < 1.1$$
where BFw is a back focus in an in-focus state on an object at infinity at the wide-angle end, and fw is a focal length of the zoom lens in the in-focus state on the object at infinity at the wide-angle end.

22. The zoom lens according to claim 1, wherein the following inequality is satisfied:
$$0.3 < Lt / ft < 3.1$$
where ft is a focal length of the zoom lens in an in-focus state on an object at infinity at the telephoto end, and Lt is a distance on the optical axis from a lens surface closest to the object to the image plane in the in-focus state on the object at infinity at the telephoto end.

23. An image pickup apparatus comprising:
a zoom lens; and
an image sensor that receives an optical image formed by the zoom lens,
wherein the zoom lens includes, in order from an object side to an image side:
a front group, an intermediate group, and a rear group, each of which includes one or more lens units,
wherein each distance between adjacent lens units changes during zooming,
wherein the front group consists of a first front lens unit with positive refractive power,
wherein the first front lens unit is fixed relative to an image plane during zooming,
wherein the intermediate group consists of, in order from the object side to the image side, a first intermediate lens unit with negative refractive power, a second intermediate lens unit with negative refractive power, and a third intermediate lens unit,
wherein the third intermediate lens unit moves from the object side to the image side during zooming from a wide-angle end to a telephoto end, and
wherein the following inequalities are satisfied:
$$0.001 < TLM 1 / fLF 1 < 0 \text{.025}$$
$$0.001 < TLM 2 / fLF 1 < 0 \text{.022}$$
$$0.1 < MLM 1 / fLF 1 < 0.39$$
where fLF1 is a focal length of the first front lens unit, TLM1 is a distance on an optical axis from a lens surface closest to an object in the first intermediate lens unit to a lens surface closest to the image plane in the first intermediate lens unit, TLM2 is a distance on the optical axis from a lens surface closest to the object in the second intermediate lens unit to a lens surface closest to the image plane in the second intermediate lens unit, and MLM1 is a moving amount, where the moving amount toward the object side is positive, of the first intermediate lens unit during zooming from the wide-angle end to the telephoto end.
